(19) United States
(12) Patent Application Publication
(10) Pub. No.: US 2007/0061802 A1
(43) Pub. Date: Mar. 15, 2007

(54) Automatic installation of PC game

(75) Inventors: Cheng Tao Tan, Taipei (TW); Jui-Te Wu, Taipei (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Via Technologies, Inc.

(21) Appl. No.: 11/348,139

(22) Filed: Feb. 6, 2006

(30) Foreign Application Priority Data
Mar. 3, 2005 (TW) 094106495

(51) Int. Cl. G06F 9/445

(52) U.S. Cl. 717/174

(57) ABSTRACT

A database is built in a computer system and includes a characteristic set, an installation data set corresponding to the characteristic set, a reference command set and an execution set corresponding to the reference command set. A specified installation data in the installation set is used to automatically and continuously execute a series of installation commands of a PC game when a characteristic of the PC game matches a characteristic in the characteristic set corresponding to the specified installation data. Alternatively, a specified execution is performed when an installation command of the PC game matches a reference command in the reference command set corresponding to the specified execution. The computer system is thus capable of automatically installing thereinto a PC game from a storage medium.

### FIELD OF THE INVENTION

The present invention relates to a method for automatically installing software, and more particularly to a method for automatically installing software from a storage medium into a computer system.

### BACKGROUND OF THE INVENTION

With the development of computing technology and the widespread availability of personal computers (PCs), household computers or personal computers can be used for a variety of applications in addition to basic functions such as internet exploring and word processing. One of the examples is for entertainment uses like games. Recently, the market of personal computer game (PC game) industry is incredibly developing. The virtual but vivid pictures and the fantabulous sound effects performed by game programs nowadays attract not only young consumers but also traditional computer users who have been not interested in games before.

Before the rise of the PC game industry, video games are the most well-known household-entertaining game devices. The popular game devices, for example, include “Family Computer”, “Super Family Computer”, “Nintendo 64” and “Game Cube” presented by Nintendo, and “Play Station” and “Play Station 2” presented by SONY, which are very successful in game device market. Furthermore, in view of the huge business potentials, even Microsoft, the leading company in Operating System, also invests a lot of money in developing “XBOX”.

In general, a video game is specifically designed to be executed by some specific device. For example, the video game developed for a PS2 device will not be compatible with XBOX device, and vice versa. A PC game, on the other hand, can be executed by computer systems of different makes or different specifications. Compared to video games, PC games are advantageous in nonspecific device requirement. However, just for the same reason, the installation of PC games into general computers is much more complicated than the installation of video games into specific devices. For playing a video game on a video game set, the only thing users need to do is to connect the host to a TV set, and insert a desired game disc or game cassette into the host. Then the user can start to play the game. On the contrary, a plurality of setup menus need to be followed for installing a PC game into a computer that is not specific to that game. Consequently, for consumers who are not familiar with computers, the interest in playing PC games might be impeded by software installation problems.

### SUMMARY OF THE INVENTION

Therefore, the present invention provides a method for automatically installing software required for executing a game in a computer.

The present invention also provides a computer system that is able to automatically install software required for executing a game when a storage medium of the game is put into the computer.

The present invention provides a method for automatically installing a PC game from a storage medium into a computer. In the method, a characteristic of a PC game is detected. The characteristic is compared with a setup database existing in the computer to obtain a comparing result. When the comparing result indicates a comparable result, installation commands of the PC game are automatically and sequentially executed according to installation data that are included in the setup database and correspond to the characteristic.

For example, the characteristic can be a name of the PC game, a size of the PC game or an identification number of the PC game recorded in the storage medium.

In an embodiment, the setup database is built in the computer with characteristics and installation data of a plurality of PC games.

In an embodiment, the setup database is installed into the computer by downloading characteristics and installation data of a plurality of PC games from a compact disc or a website.

In an embodiment, the setup database is updated via a compact disc or internet.

In an embodiment, the setup database is updated by adding the characteristic and installation data of the PC game into the setup database when the comparing result indicates an incomparable result.

For example, the storage medium is a disc or a website.

For example, the installation commands comprise automatically entering a preset language; automatically entering a selective item associated with accepting claim and agreement; automatically entering a preset directory for storing the PC game in the computer; and/or automatically entering next step or finishing confirmation when a dialogue window has completed.

In an embodiment, the PC game automatically starts after the installation commands are executed.

In another aspect, the present invention provides a method for automatically installing a PC game from a storage medium into a computer, comprising steps of: executing as installation command of a PC game to generate a word string or word combination; comparing the word string or word combination with a setup database existing in the computer to obtain a comparing result; automatically entering a preset input and executing next installation command of the PC game when the comparing result indicates a comparable result; and repeating the comparing step and the automatically entering and executing steps until the installation of the PC game has completed or an incomparable result occurs.

Preferably, the method further comprises a step of entering a manual installation mode when the comparing result indicates an incomparable result.

Preferably, the method further comprises a step of updating the setup database by adding the word string or word combination of the PC game into the setup database when the comparing result indicates an incomparable result.

In a further aspect, the present invention provides a computer system capable of automatically installing thereinto a PC game from a storage medium, built in a database that includes a characteristic set, an installation data set corresponding to the characteristic set, a reference command set and an execution set corresponding to the reference command set. A specified installation data in the installation set is used to automatically and continuously execute a series of installation commands of a PC game when a characteristic of the PC game matches a characteristic in the characteristic set corresponding to the specified installation data. Alternatively, a specified execution is performed when an installation command of the PC game matches a reference command in the reference command set corresponding to the specified execution.

In an embodiment, the installation command is determined to match the reference command when a word string or word combination generated by executing the installation command is common to data included in the reference command set.

### BRIEF DESCRIPTION OF THE DRAWINGS

The above contents of the present invention will become more readily apparent to those ordinarily skilled in the art after reviewing the following detailed description and accompanying drawings, in which:

FIG. 1(a)˜(e) are schematic diagrams exemplifying dialogue windows appearing stage by stage for installing a PC game;

FIG. 2 is a block diagram illustrating a computer system capable of automatically installing a PC game from a storage medium of a PC game according to the present invention;

FIG. 3(a) is a block diagram illustrating typical information stored in a storage medium of a PC game;

FIGS. 3(b) and 3(c) are block diagrams illustrating a configuration of the setup database of FIG. 2 according to two embodiments of the present invention; and

FIG. 4 a flowchart summarizing a method for automatically installing a PC game according to an embodiment of the present invention.

### DETAILED DESCRIPTION OF THE PREFERRED EMBODIMENT

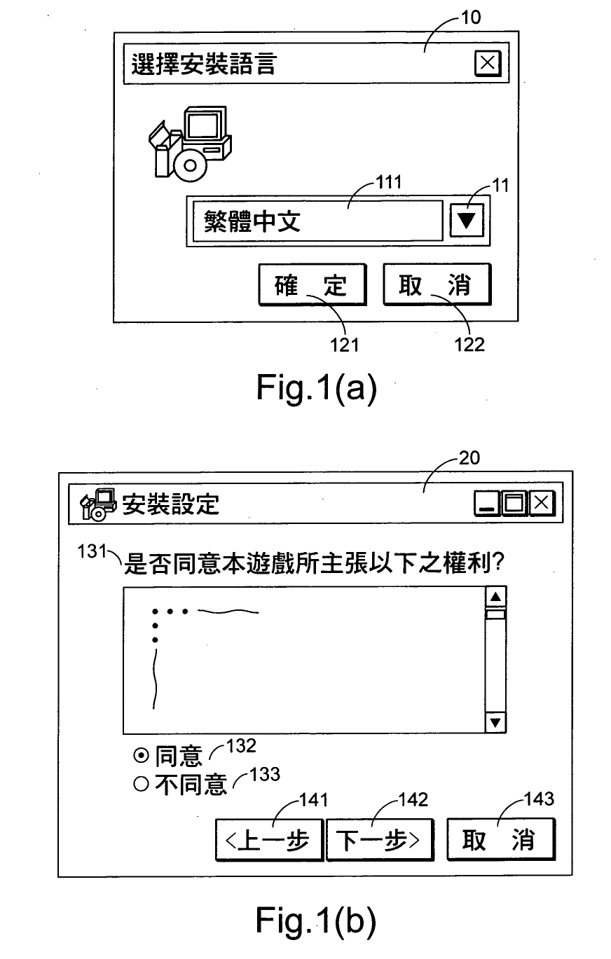

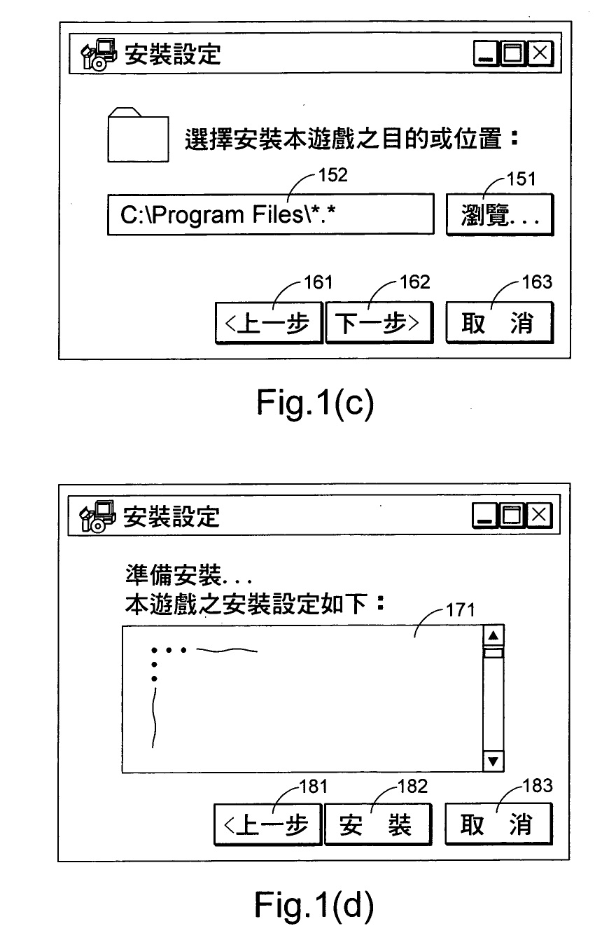

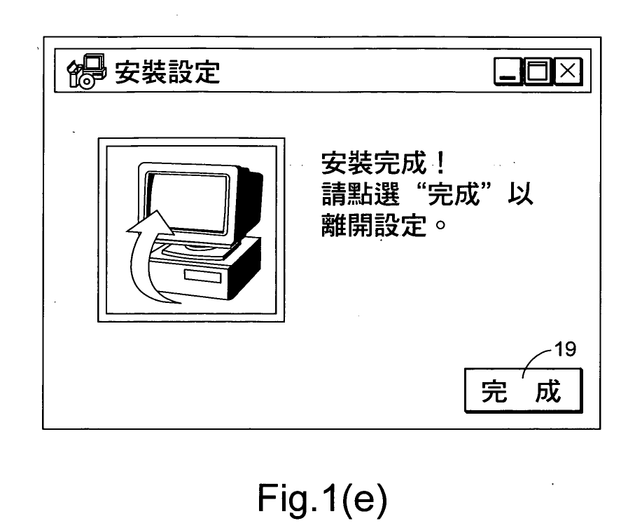

Conventionally, a plurality of setup menus need to be followed step by step for installing a PC game from a storage medium such as a CD-ROM into a computer, as exemplified in FIGS. 1(a)˜(e). In this example, a Chinese-version CD-ROM for Taiwan is used for storing the PC game. The installation starts with language selection 10 (FIG. 1(a)). Though a pull-down menu 11, a plurality of language selective items are provided for selection. For a native Chinese speaker, the “traditional Chinese” item 111 would be the choice. Then click on the “OK” virtual button 121. Otherwise, click on the “Cancel” virtual button 122 to exit. After the language is selected, Setup 20 is to be executed. Generally, some claim or agreement 131 needs to be approved, and subsequent setup cannot go on if the “accept” item 132 is not marked or the “refuse” item 133 is marked instead of the “accept” item 132 (FIG. 1(b)). Then setup proceeds to FIG. 1(c) by clicking on the “next” virtual button 142. If the language is to be changed, click on the “previous” virtual button 141 to go back to the menu of Figure l(a). Otherwise, click on the “cancel” virtual button 143 to exit. In FIG. 1(c), the destination where the program to be stored is stored is chosen via the browsing virtual button 151 and the directory list 152. The symbol “*.*” is not really shown on the monitor but just an indication of a filename. Afterwards, one of the virtual buttons “previous” 161, “next” 162 and “cancel” 163 is clicked. Once “next” 162 is selected, install settings 171 are summarized (FIG. 1(d)) and the setup is ready to go. If there is any option to be changed before installation, click the “previous” virtual button 181 to go back, or click the “install” virtual button 182 to execute installation. Likewise, the “cancel” virtual button 183 for exiting the installation is still available. Then, the frame of FIG. 1(e) is shown when the installation completes. Click the “finish” virtual button 19 to exit.

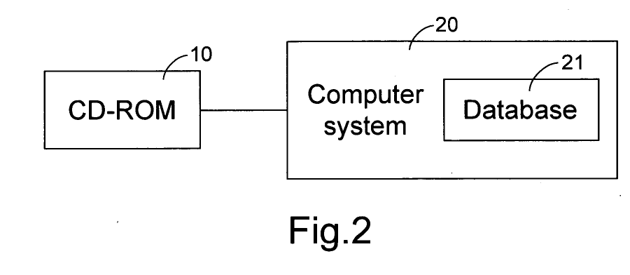

Most setup menus as described above are routines for those who are experienced in computers but still confuse those who are not familiar with computer operations. Therefore, according to an embodiment of the present invention, a computer system 20 is provided with a setup database 21 recording therein information of a plurality of PC games, as shown in FIG. 2. By reading information from the storage medium of the PC game to be installed, e.g. a CD-ROM 10 loaded in a disc drive of the computer 20 or an online game website, and looking up corresponding information in the setup database 21, the above setup menus can be continuously and automatically executed so as to simplify the installation. For example, the “traditional Chinese” item 111 and then the “OK” virtual button 121 are automatically enabled when the frame of FIG. 1(a) appears; the “accept” item 132 and the “next” virtual button 142 are automatically enabled when the frame of FIG. 1(b) appears; the preset directory 152 and the “next” virtual button 162 are automatically enabled when the frame of FIG. 1(c) appears; the “install” virtual button 182 is automatically enabled when the frame of FIG. 1(d) appears; and the “finish” virtual button 19 is automatically enabled when the frame of FIG. 1(e) appears. Accordingly, the installation of the PC game can be automatically performed.

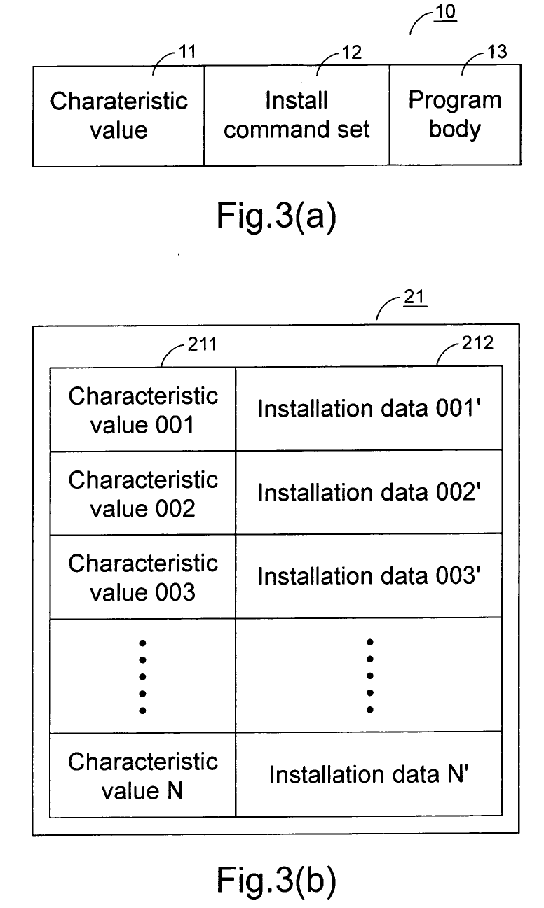

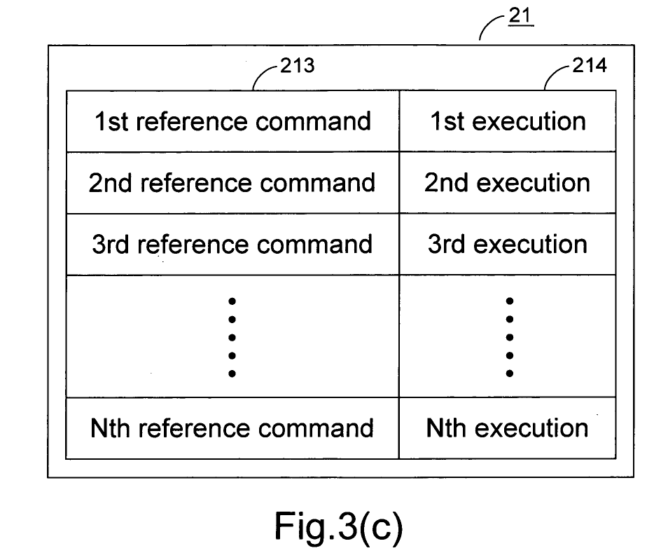

The setup database 21 can be built by collecting and recording information of currently commercialized, PC games. In general, the CD-ROM 10 where a PC game program to be installed is stored is recorded therein a characteristic value 11, a series of installation commands 12 and a program body 13, as shown in FIG. 3(a). The characteristic value 11 has not to be a “value” but can be any suitable number, code or symbol that forms distinctive information of the CD-ROM. For example, the characteristic value 11 can be the name of the game, the size of the program or the ID code of the software given by the producer. Therefore, the database 21 according to the present invention can be made to store a characteristic value set 211 consisting of characteristic values 001˜N and an installation data set 212 consisting of installation data 001′˜N′, each pair corresponding to a PC game, as shown in FIG. 3(b). The characteristic values 001˜N, of course, have the same format as the characteristic value 11. By comparing the characteristic value 11 with the characteristic value set 211 in the database 21, whether there is any specific installation data among the installation data set 212 corresponding to the PC game to be installed can be found. If one of the characteristic values 211 completely matches the characteristic value 11, e.g. the characteristic value 001, then the installation data 001′ will be the data for installing the PC game carried by the CD-ROM 10. Accordingly, the setup menus and required clicks for successfully installing the PC game can be realized and executed according to the installation data 001′.

However, not all the PC games to be installed would be available in the database 21 or not all the preset clicks are acceptable. Therefore, it is preferred that the database 21 can be updated and/or the PC game can alternatively be installed manually and/or the PC game can still be automatically installed even if no matching result is found. The updating operation of a PC game can be performed via disc or internet. The switching of the installation mode from the automatic installation mode to the manual installation mode can be achieved by adding a request window before the setup procedures of FIG. 1.

For achieving the purpose of automatically installing a PC game when the characteristic value 11 of the PC game recorded in the CD-ROM does not match any characteristic value 211 in the database 21, another comparing algorithm is suggested herein. Although some PC games may be excluded from the existent database 21, the setup menus and required clicks for successfully installing the PC games might quite similar to the ones described above with reference to FIGS. 1(a)˜(e). Therefore, in another embodiment of the present invention, the database 21 includes a set of reference command data 213 and corresponding input and execution 214, as illustrated in FIG. 3(c). The installation commands 12 are compared with the set of reference command data 213 in the database 21 in sequence to identify a currently processing command. Aside from comparing the command itself, it can alternatively be word strings or word combinations generated by executing the installation commands 12 to be compared with reference command data 213 of the database 21. Of course, the reference command data 213 should be word data in this case. For example, if a word string or word combination relating to “language” appearing in the dialogue window by executing one of the installation commands 12 is identified from the set of reference command data 213 as the first reference command, the corresponding selection “traditional Chinese” followed by “OK” will be executed, e.g. first execution. Likewise, the word string or word combination relating to “agreement” directs to the automatic selection of “accept” followed by “next”; the word string or word combination relating to “destination” directs to the automatic selection of a preset directory followed by “next”; the word string or word combination relating to “ready to install” directs to the automatic selection “install” followed by “next”; and the word string or word combination relating to “install complete” directs to the automatic selection of “finish”. In this manner, the installation of the PC game can be automatically performed. Preferably, the information of this PC game including characteristic value and installation data is added to the database 21 to facilitate updating the database 21.

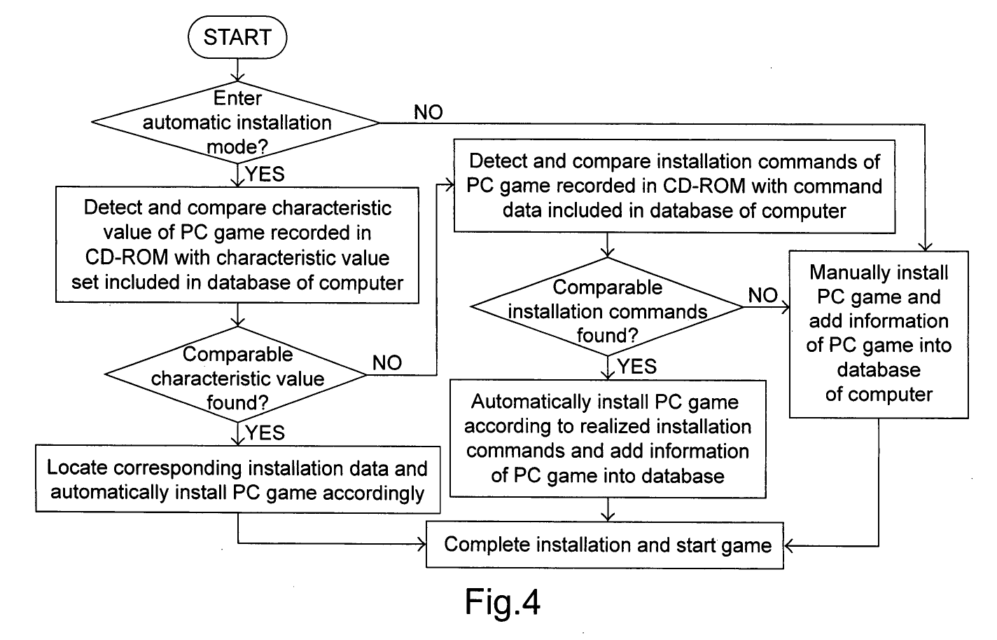

The above embodiments can be combined in a further embodiment so that the database 21 includes both the characteristic value data of FIG. 3(b) and the reference command data of FIG. 3(c). In this embodiment, which is illustrated in the flowchart of FIG. 4, the installation will be switched to the manual mode if the characteristic value 11 recorded in the CD-ROM 10 neither comply with any characteristic value 211 nor correspond to any command data 213. In other words, the automatic installation function will be disabled. Preferably, the information of this PC game including characteristic value and installation data is added to the database 21 to facilitate updating the database 21.

It is understood from the above descriptions that by building up a proper database in a computer, a PC game can be automatically installed into the computer by referring to the information of the database. Therefore, the computer can be easily used by those who are not familiar with computer operations to play PC games. The database can be built in the computer or installed into the computer via disc or internet.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A method for automatically installing a PC game from a storage medium into a computer, comprising steps of:
detecting a characteristic of a PC game;
comparing said characteristic with a setup database existing in the computer to obtain a comparing result; and
automatically and sequentially executing installation commands of said PC game according to installation data included in said setup database and corresponding to said characteristic when said comparing result indicates a comparable result.

2. The method according to claim 1 wherein said characteristic is a name of said PC game, a size of said PC game or an identification number of said PC game recorded in the storage medium.

3. The method according to claim 1 wherein said setup database is built in the computer with characteristics and installation data of a plurality of PC games.

4. The method according to claim 1 wherein said setup database is installed into the computer by downloading characteristics and installation data of a plurality of PC games from a compact disc or a website.

5. The method according to claim 1 wherein said setup database is updated via a compact disc or internet.

6. The method according to claim 1 further comprising a step of updating said setup database by adding said characteristic and installation data of said PC game into said setup database when said comparing result indicates an incomparable result.

7. The method according to claim 1 wherein said storage medium is a disc or a website.

8. The method according to claim 1 wherein said installation commands comprise one selected from a group consisting of:
automatically entering a preset language;
automatically entering a selective item associated with accepting claim and agreement;
automatically entering a preset directory for storing said PC game in the computer; and
automatically entering next step or finishing confirmation when a dialogue window has completed.

9. The method according to claim 1 further comprising a step of automatically starting said PC game after said installation commands have been executed.

10. A method for automatically installing a PC game from a storage medium into a computer, comprising steps of:
executing an installation command of a PC game to generate a word string or a word combination;
comparing said word string or said word combination with a setup database existing in the computer to obtain a comparing result;
automatically entering a preset input and executing next installation command of said PC game when said comparing result indicates a comparable result; and
repeating said comparing step and said automatically entering and executing steps until the installation of said PC game has completed or an incomparable result occurs.

11. The method according to claim 10 further comprising a step of entering a manual installation mode when said comparing result indicates said incomparable result.

12. The method according to claim 10 further comprising a step of updating said setup database by adding said word string or said word combination of said PC game into said setup database when said comparing result indicates said incomparable result.

13. The method according to claim 10 wherein said setup database is updated via a compact disc or internet.

14. The method according to claim 10 wherein said storage medium is a disc or a website.

15. The method according to claim 10 further comprising a step of automatically starting said PC game after said installation commands have been executed.

16. A computer system capable of automatically installing thereinto a PC game from a storage medium, built therein a database that includes a characteristic set, an installation data set corresponding to said characteristic set, a reference command set and an execution set corresponding to said reference command set, wherein a specified installation data in said installation set is used to automatically and continuously execute a series of installation commands of a PC game when a characteristic of said PC game matches a characteristic in said characteristic set corresponding to said specified installation data, or a specified execution is performed when an installation command of said PC game matches a reference command in said reference command set corresponding to said specified execution.

17. The computer system according to claim 16 wherein said installation command is determined to match said reference command when a word string or word combination generated by executing said installation command is common to data included in said reference command set.
